(19) United States
(12) Patent Application Publication
(10) Pub. No.: US 2006/0146459 A1
(43) Pub. Date: Jul. 6, 2006

(54) ESD component ground clip

(75) Inventor: Lance L. Sundstrom, Pinellas Park, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/030,657

(22) Filed: Jan. 4, 2005

(51) Int. Cl. H02H 9/00

(52) U.S. Cl. 361/56

(57) ABSTRACT

An ESD protection system for an IC device. An ESD protection circuit is comprised of a plurality of resistors and a common ground bus. The first terminal of each resistor is coupled to an associated pin of an IC device while the second terminal of each resistor is coupled to the common ground bus. The common ground bus is coupled with a reference ground. A clip holds the ESD protection circuit to pins of the IC device. As the IC device is transported, the present invention maintains a continuous controlled DC path to reference ground on every pin of the IC device, thus preventing damaging electrostatic charges from accumulating on the IC device pins, or discharging through the IC device.

### GOVERNMENT LICENSE RIGHTS

The U.S. Government may have certain rights in the present invention as provided for by the terms of Contract No. N00030-04-C-0010 awarded by the Dept. of Navy Strategic Systems Programs.

### TECHNICAL FIELD

The present invention generally relates to the field of semiconductor chip devices and more specifically the protection of electronic devices from electrostatic discharge damage.

### BACKGROUND

Testing and installation of integrated circuit (IC) devices typically requires the removal of an IC device from electrostatic discharge (ESD) protection packaging before installation of the IC device into a circuit wiring board. During transport of the IC device from its ESD protection packaging to the circuit wiring board, ambient electrical noise from the environment can cause individual pins on the device to develop a static charge. A damaging static charge can also develop on isolated (floating) traces of the circuit wiring board itself. As the device is installed into the circuit wiring board, (also sometimes called a printed wiring board (PWB), a printed circuit board (PCB), or a circuit board) any charge differential built up between the IC device's pins and the PWB will result in an electrostatic discharge at or near the initial point of contact, potentially damaging the IC device. The dissipation of the static differential charge through the IC device can be sufficient to destroy the device. Another source of electrostatic discharge damage is from the contact of one or more of the IC device's pins with a technician who physically handles the IC device after it is removed from the ESD protective packaging. If contact is made between the technician and the IC device, the discharge through the device of any charge can be sufficient to destroy the device.

Current practices in the art do not adequately protect IC devices from ESD damage during the process of installing such devices into PWBs. For damaging static discharge from floating PWB traces, installation of shunt resistances is sometimes effective. The installation of a shunt resistance between the PWB trace and ground allows static charges to immediately dissipate to ground. However, adding shunt resistances to all floating PWB traces is not always possible or practical because of physical limitations involved in installing such resistances and because the shunt resistances may adversely affect the electrical functioning of the device. Additionally, the installation of shunt resistances on the PWB does not prevent the accumulation of a charge on the IC device itself prior to installation, or prevent damage to the device caused upon installation. For the problem of ESD damage caused by contact between a device pin and a technician, it is common for technicians to wear protective straps such as ESD wrist straps. ESD wrist straps connect the operator to earth ground through a high impedance resistor. These ESD protective straps offer only limited protection because the high impedance connection between the technician and ground still allows the technician to pick up charges from ambient voltage noise. Additionally, the IC device being handled by the technician is itself still susceptible to developing a charge on its pins and may still be damaged from the dissipation of charge through the technician.

For the reasons stated above and for other reasons stated below which will become apparent to those skilled in the art upon reading and understanding the specification, there is a need in the art for an apparatus which effectively prevents ESD damage to IC devices during installation.

### SUMMARY

The Embodiments of the present invention address the problems of ESD damage by providing a controlled discharge path for each pin of an IC device to Earth ground, or any other desirable reference potential.

In one embodiment, an ESD protection system for an IC device is provided. The system comprising an ESD protection circuit and a clip to hold the ESD protection circuit to pins of the IC device.

In another embodiment, an apparatus for protecting IC devices from ESD damage is provided. An ESD protection circuit includes a plurality of resistors and a common ground bus. The first terminal of each resistor is electrically coupled to an associated pin of the IC device. The second terminal of each resistor is electrically coupled to the common ground bus. A clamp is adapted to hold the ESD protection circuit to the pins of the IC device.

In another embodiment, another apparatus for protecting IC devices from ESD is provided. The apparatus comprises an IC device test clip and an ESD protection circuit including a plurality of resistors and a common ground bus. The first terminal of each resistor is electrically coupled to an associated test pin of the IC device test clip. The second terminal of each resistor is electrically coupled to the common ground bus.

In still another embodiment, a method for protecting IC devices from ESD damage is provided. The method comprises coupling each pin of an IC device to a reference voltage; moving the IC device from a starting location to a desired location, where the coupling between the reference voltage and each pin of the IC device is constantly maintained throughout the transfer; installing the IC device at the desired location; and removing the coupling between the reference voltage and each pin of the IC device.

In still another embodiment, an ESD protection system for an IC device is provided. The system comprises an ESD protection circuit means and a means for holding the ESD protection circuit means to a plurality of pins of the IC device.

In still another embodiment, an ESD protection circuit module for an IC device test clip is disclosed. The module comprises a plurality of resistors and a common ground bus, the first terminal of each resistor removabley coupled to an associated test pin of the IC device test clip, and the second terminal of each resistor electrically coupled to the common ground bus.

### DRAWINGS

The present invention can be more easily understood and further advantages and uses thereof more readily apparent, when considered in view of the description of the preferred embodiments and the following figures in which:

FIG. 1 is an electrical schematic diagram illustrating an ESD Component Ground Clip of one embodiment of the current invention;

FIGS. 2a and 2b are diagrams illustrating an ESD Component Ground Clip of one embodiment of the current invention. FIG. 2a is a side view and FIG. 2b is a front view of the current invention;

FIG. 3 is a diagram illustrating an ESD Component Ground Clip of another embodiment of the current invention; and

FIG. 4 is a diagram illustrating an ESD Component Ground Clip of another embodiment of the current invention.

In accordance with common practice, the various described features are not drawn to scale but are drawn to emphasize features relevant to the present invention. Reference characters denote like elements throughout Figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

The embodiments of the ESD Component Ground Clip address the problems of electrostatic discharge damage by providing a controlled discharge path for each pin of an IC device to Earth ground, or any other desirable reference potential. With this invention, static charge cannot accumulate on the pins of an IC device because the induced charge will immediately dissipate to ground through the invention. Thus, when the IC device is installed into a PWB, each pin will be free of static charge. Moreover, should the IC device come in contact with an object or person holding a damaging static charge, the charge will dissipate to ground through the invention, rather than through the internal circuitry of the IC device.

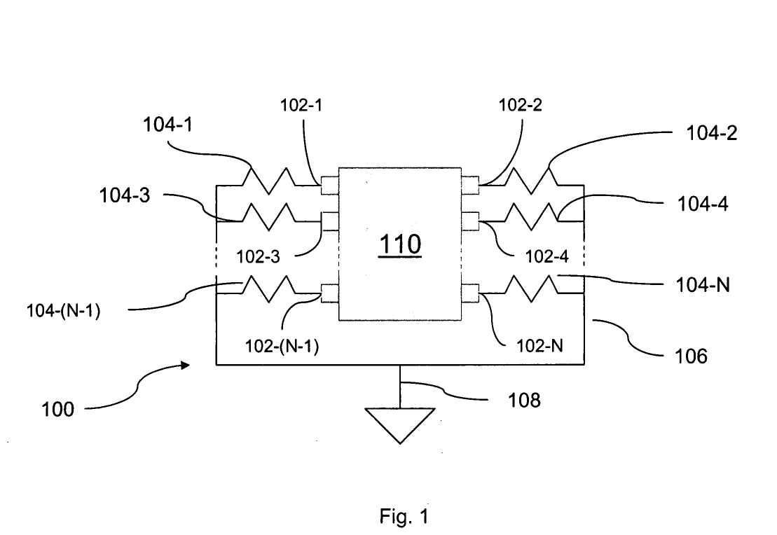

FIG. 1 is an electrical schematic of one embodiment of an ESD Component Ground Clip 100 in combination with an N-pin IC device 110. As illustrated, the ESD protection circuit of an ESD Component Ground Clip includes a plurality of resistors 104-1 through 104-N, a common ground bus 106 and a reference ground 108. One terminal of each resistor 104-1 through 104-N is electrically coupled with one associated pin from the IC device, 102-1 through 102-N respectively, such that each pin is coupled to one resistor. The second terminal of each resistor 104-1 through 104-N is electrically coupled to the second terminal of every other resistor 104-1 through 104-N to form a common ground bus 106. The common ground bus is coupled with a reference ground 108. As the combination of the ESD Component Ground Clip 100 and the IC device 110, is transported from the IC device's ESD protective packaging to a PWB (or vice-versa) the present invention will maintain a continuous controlled DC path to reference ground on every pin of the IC device, thus preventing damaging electrostatic charges from accumulating on the IC device pins, or discharging through the IC device.

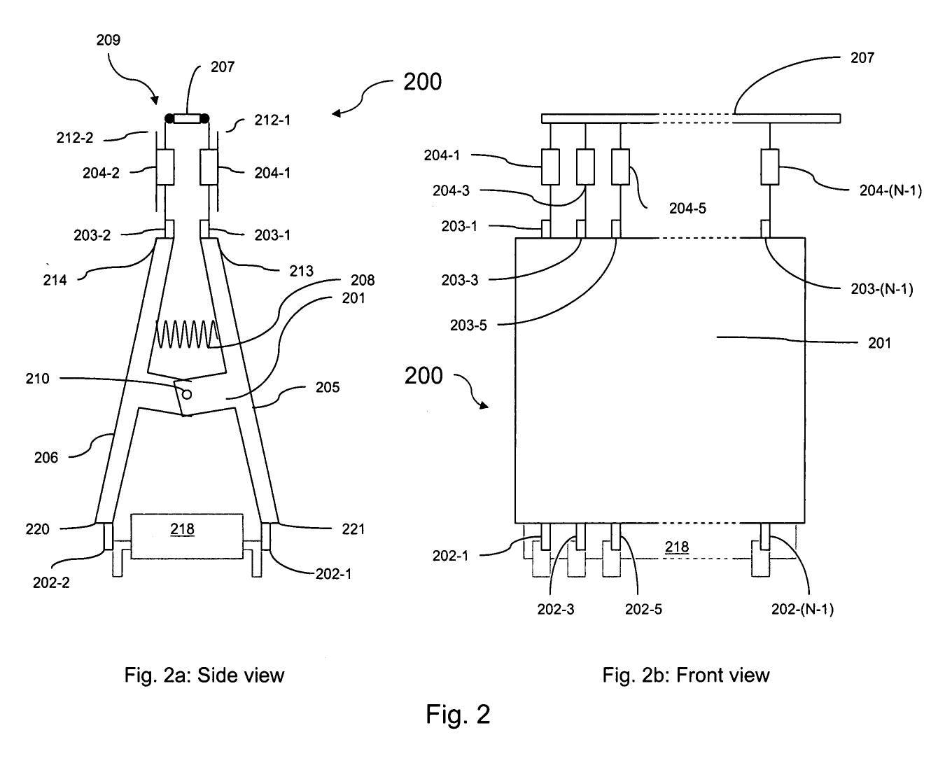

In FIGS. 2a and 2b, an ESD Component Ground Clip 200 of one embodiment of the present invention is illustrated. In this embodiment, the present invention is practiced by combining a modified standard N-pin dual inline package (DIP) test clip 201 with a typical N-pin DIP IC device 218. In typical DIP test clips, the test clip comprises a first leg 205 and a second leg 206 pivotally connected by one or more pins 210, with a biasing spring 208 that pushes manipulating ends 213 and 214 of respective clip legs 205 and 206 apart. N test terminals 203-1 through 203-N, located at the adjacent manipulating ends 213 and 214 of respective legs 205 and 206, are each electrically coupled with an associated DIP pin coupling point 202-1 through 202-N. One example of such a test clip is the Pomona Electronics DIP Clip model 4340A. To create an ESD protection circuit 209 from the DIP test clip, respective N resistors (204-1 through 204-N), are coupled to respective N test terminals (203-1 through 203-N). The first terminal of each resistor 204-1 through 204-N is soldered to an associated test terminal 203-1 through 203-N of the test clip 201. The second terminal of each resistor 204-1 through 204-N is soldered to a common ground bus wire 207, electrically coupling all the second terminals of each resistor 204-1 through 204-N. In one embodiment, the resistors 204-1 through 204-N are covered with electrostatic discharge tape 212-1 and 212-2, to insulate them from contact with other objects or persons. Although, the inventor uses a resistance of 1000 ohms for the resistors 204-1 through 204-N, other embodiments may vary the resistance value and may omit the electrostatic discharge tape 212. Additional embodiments may substitute other forms of standard IC device component test clips for the DIP test clip 201.

In one embodiment, ESD protection circuit 209 is an ESD protection circuit module which is removabley coupled to test terminals 203-1 through 203-N so that the ESD protection circuit module may be attached or removed from test clip 201 as needed. In one embodiment, a plurality of the respective N resistors (204-1 through 204-N) for each leg 205 and 206 can be packaged in housings separately to increase the convenience of installing and removing the ESD protection circuit module.

To use this embodiment of the present invention, the common ground bus 207 is electrically coupled to Earth ground, or other reference potential, with a standard wire lead and test clip. The manipulating end 213 of first leg 205 and manipulating end 214 of second leg 206 are pushed together so that the engaging end 221 of first leg 205 and engaging end 220 of second leg 206 spread apart. The clip 201 is held over the target IC device 218 and then released such that each of the pin coupling points 202-1 through 202-2 forms a friction held electrical connection (also called a pressure contact) with an associated pin on the IC device 218. The clip is then used to pick up the IC device and transport it to the desired destination. As the IC device is transferred from its ESD protective packaging to the PWB (or vice-versa) the present invention will maintain a continuous controlled DC path to reference ground on every pin, thus preventing damaging electrostatic charges from accumulating on the IC device pins, or discharging through the IC device.

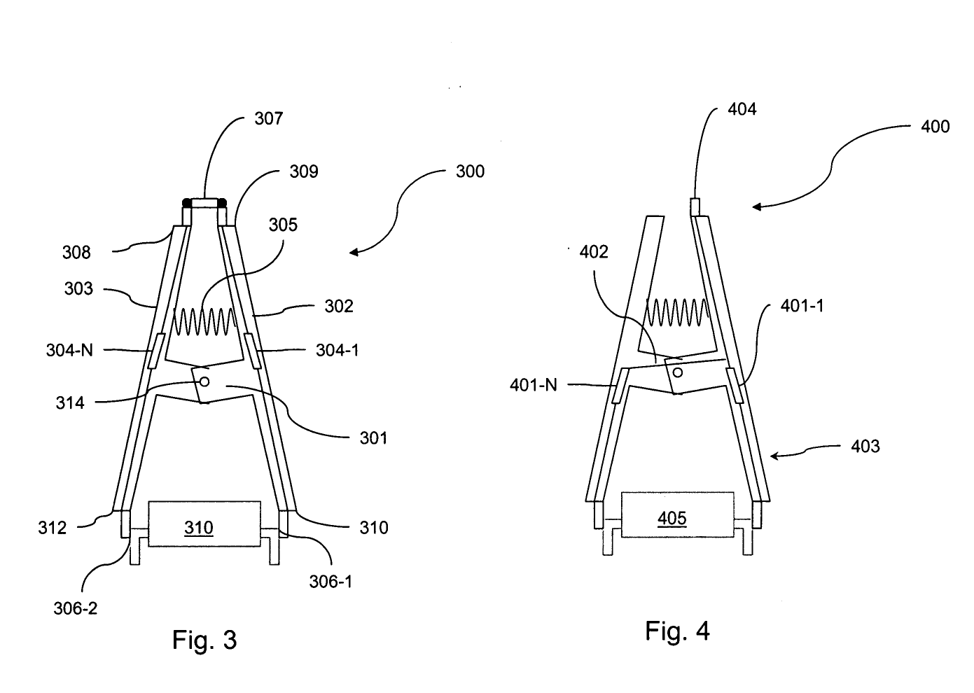

In FIG. 3, an ESD Component Ground Clip 300 of one embodiment of the present invention is illustrated. In this embodiment, the ESD protection circuit is partially integrated into a clip 301. The clip 301 comprises a first leg 302 and a second leg 303 pivotally connected by one or more pins 314. A biasing spring 305 pushes the manipulating end 309 of first leg 302 and manipulating end 308 of second leg 303 apart and the engaging end 310 of first leg 302 and engaging end 312 of second leg 303 together to hold an N-pin IC device 310. In this embodiment, a plurality of resistors 304-1 through 304-N, are integrated into the clip legs 302 and 303. The first terminal of each resistor 304-1 through 304-N is coupled to an associated device pin coupling point 306-1 though 306-N. The second terminal of each resistor 304-1 through 304-N is externally coupled to a common ground bus 307, electrically coupling all the second terminals of each resistor 304-1 through 304-N. In other embodiments, resistors 304-1 through 304-N of the ESD protection circuit may be removable to allow the user to select the resistance value they desire to use.

In FIG. 4, another embodiment 400 is illustrated in combination with an IC device 405. In this embodiment, a plurality of resistors 401-1 through 401-N and a common ground bus 402, comprising the ESD protection circuit, are integrated into the legs of a clip 403. The common ground bus 402 is coupled with an external ground connection point 404. The external ground connection point 404 is electrically coupled to Earth ground, or other reference potential, with a standard wire lead and test clip. In other embodiments, the resistors 401-1 through 401-N of the ESD protection circuit may be removable to allow the user to select the resistance value they desire.

In other embodiments, the clip of the present invention may be modified in shape to accommodate clamping other forms of standard IC device packages other than a dual inline package. These other forms of standard IC device packages include but are not limited to: a pin grid array (PGA) package; a single in-line (SIP) package; a plastic leaded chip carrier (PLCC); or quad flat pack (QFP) package.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An ESD protection system for an IC device, the ESD protection system comprising:
an ESD protection circuit; and
a clip adapted to hold the ESD protection circuit to pins of the IC device.

2. The ESD protection system of claim 1, wherein the ESD protection circuit further comprises:
a plurality of resistors, each resistor having a first and second terminal;
a common ground bus; and
a ground connection, the first terminal of each resistor coupled to an associated pin of the IC device, the second terminal of each of the plurality of resistors electrically coupled to the common ground bus, and the ground bus electrically coupled to the ground connection.

3. The ESD protection system of claim 2, wherein the clip further comprises:
a first leg having a manipulating end and an engaging end;
a second leg having a manipulating end and an engaging end, the second leg and first leg being pivotally connected;
a biasing spring having two ends, the first end connected to the first leg and the second end connected to the second leg;
a plurality of IC device pin coupling points;
a plurality of test terminals; and
a plurality of electrical conductors, each electrical conductor electrically coupled to an associated test terminal and an associated IC device pin coupling point, wherein each resistor of the ESD protection circuit is electrically coupled to an associated pin of the IC device through an associated test terminal, electrical conductor, and IC device pin coupling point.

4. The ESD protection system of claim 2 further comprising:
ESD protection tape, where the ESD protection tape is adhered to exposed electrical components of the ESD protection circuit.

5. The ESD protection system of claim 2, wherein the clip further comprises:
a first leg having a manipulating end and an engaging end;
a second leg having a manipulating end and an engaging end, the second leg and first leg being pivotally connected, wherein one or more of the plurality of resistors of the ESD protection circuit are housed within the first leg and a different one or more of the plurality of resistors of the ESD protection circuit are housed within the second leg;
a biasing spring having two ends, the first end connected to the first leg and the second end connected to the second leg;
a plurality of IC device pin coupling points; and
a plurality of test terminals, wherein the first terminal of each resistor of the ESD protection circuit is electrically coupled to an associated pin of the IC device through an associated IC device pin coupling point, and where the second terminal of each resistor of the ESD protection circuit is electrically coupled to the common ground bus through an associated test terminal.

6. The ESD protection system of claim 5, wherein one or more of the resistors of the ESD protection circuit are removabley housed within the second leg and first leg of the clip.

7. The ESD protection system of claim 2, wherein the clip further comprises:
a first leg having a manipulating end and an engaging end;
a second leg having a manipulating end and an engaging end, the second leg and first leg connected pivotally near the center of each leg, wherein one or more of the plurality of resistors of the ESD protection circuit are housed within the first leg and one or more of the plurality of resistors of the ESD protection circuit are housed within the second leg, and wherein the common ground bus of the ESD protection circuit is embedded within the first leg and the second leg;
a biasing spring having two ends, the first end connected to the first leg and the second end connected to the second leg;
a plurality of IC device pin coupling points; and
an external ground connection point, wherein the first terminal of each resistor of the ESD protection circuit is electrically coupled to an associated pin of the IC device through an associated IC device pin coupling point, and wherein the common ground bus is electrically coupled to the external ground connection point.

8. The ESD protection system of claim 7, wherein one or more of the resistors of the ESD protection circuit are removabley housed within the second leg and first leg of the clip.

9. The ESD protection system of claim 2, where the clip further comprises:
a standard IC device test clip.

10. An apparatus for protecting IC devices from ESD damage comprising:
an ESD protection circuit, the ESD protection circuit including a plurality of resistors and a common ground bus, the first terminal of each resistor electrically coupled to an associated pin of the IC device, and the second terminal of each resistor electrically coupled to the common ground bus; and
a clamp adapted to hold the ESD protection circuit to the pins of an IC device.

11. An apparatus for protecting IC devices from ESD damage comprising:
an IC device test clip; and
an ESD protection circuit, the ESD protection circuit including a plurality of resistors and a common ground bus, the first terminal of each resistor electrically coupled to an associated test pin of the IC device test clip, and the second terminal of each resistor electrically coupled to the common ground bus.

12. The apparatus for protecting IC devices from ESD damage of claim 11, further comprising:
ESD protection tape, where the ESD protection tape is adhered to exposed electrical components of the ESD protection circuit.

13. A method for protecting IC devices from ESD damage, the method comprising:
coupling each pin of an IC device to a reference voltage;
moving the IC device from a starting location to a desired location, where the coupling between the reference voltage and each pin of the IC device is constantly maintained throughout the transfer;
installing the IC device at the desired location; and
removing the coupling between the reference voltage and each pin of the IC device.

14. The method of claim 13, wherein each pin of the IC device is individually coupled to the reference voltage through a resistor.

15. The method of claim 13, wherein the reference voltage is earth ground.

16. An ESD protection system for an IC device, the ESD protection system comprising:
an ESD protection circuit means; and
means for holding the ESD protection circuit means to a plurality of pins of the IC device.

17. The ESD protection system of claim 16, wherein the ESD protection circuit means further comprises:
a plurality of electrical resistance means;
a common ground bus means;
means for coupling each pin of the plurality of pins of an IC device to an associated electrical resistance means of the plurality of electrical resistance means; and
means for coupling the plurality of electrical resistance means to the common ground bus means.

18. The ESD protection system of claim 17, wherein the ESD protection circuit means further comprises:
means for coupling the common ground bus means to ground.

19. An ESD protection circuit module for an IC device test clip, the module comprising:
a plurality of resistors and a common ground bus, the first terminal of each resistor removabley coupled to an associated test pin of the IC device test clip, and the second terminal of each resistor electrically coupled to the common ground bus.

20. The module of claim 19, further comprising:
ESD protection tape, where the ESD protection tape is adhered to exposed electrical components of the ESD protection circuit.

21. The module of claim 19, wherein a plurality of the plurality of resistors are housed in one or more housings.
